(19) United States
(12) Patent Application Publication
(10) Pub. No.: US 2012/0290931 A1
(43) Pub. Date: Nov. 15, 2012

(54) APPARATUS AND METHOD FOR ARRANGING SUPPLEMENTARY INFORMATION FOR MEDIA ELEMENTS

(75) Inventors: Mikko Nurmi, Tampere (FI); Daniel González, Barcelona (ES)

(73) Assignee: Nokia Corporation

(21) Appl. No.: 13/107,289

(22) Filed: May 13, 2011

(51) Int. Cl. G06F 3/048; G06K 9/34; G09G 5/00

(52) U.S. Cl. 715/716; 345/620; 382/173

(57) ABSTRACT

In accordance with an example embodiment of the present invention, a method is provided, comprising: detecting an image associated with a set of media elements, selecting a sub-portion of the image, and associating the sub-portion of the image with a media element of the set of media elements.

### FIELD

The present invention relates to an apparatus and a method for arranging supplementary information for media elements.

### BACKGROUND

When users browse or retrieve one or more pieces of music from a music database stored in the electronic device, a menu or a list of pieces of music is displayed on the display unit of the electronic device. The menu or list shows, usually in text mode, a large number of titles, names of performers, names of composers etc. of the pieces of music to be selected. The users need to select what they want from the menu or list based on a certain rule such as alphabet order.

### SUMMARY

Various aspects of examples of the invention are set out in the claims.

According to an aspect, an apparatus is provided, comprising at least one processor; and at least one memory including computer program code, the at least one memory and the computer program code configured to, with the at least one processor, cause the apparatus at least to perform: detect an image associated with a set of media elements, select a sub-portion of the image, and associate the sub-portion of the image with a media element of the set of media elements.

According to an aspect, a method is provided, comprising: detecting an image associated with a set of media elements, selecting a sub-portion of the image, and associating the sub-portion of the image with a media element of the set of media elements.

According to an example embodiment, the sub-portion of the image is displayed during one or more of playing said media element of the set of media elements, displaying information on said media element, and displaying a view with information on the set of media elements.

According to another example embodiment, the number of media elements in the set of media elements is detected, and the image to a number of sub-portions is divided on the basis of the number of media elements.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of display list view;

FIG. 2 illustrates use of image sub-portions in accordance with an example embodiment of the invention;

FIGS. 3 to 5 illustrate methods according to example embodiments of the invention;

FIGS. 6 to 7 illustrate display views according to example embodiments of the invention; and

FIG. 8 illustrates an electronic device in accordance with an example embodiment of the invention.

### DETAILED DESCRIPTION

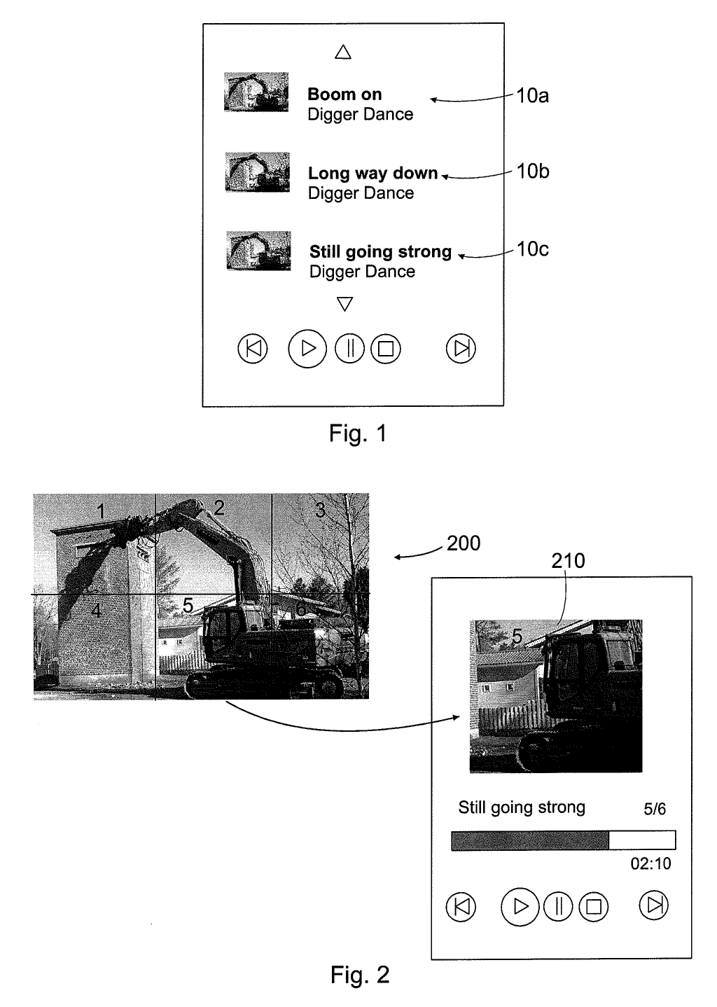

FIG. 1 provides an example of list view of music tracks 10a-10c of an album. An album cover image is shown for each of the tracks in the album. Since the same image is shown for each track, the user is not provided with any further visual aid to differentiate between the songs, but instead will need to read the titles.

FIG. 2 illustrates generation and use of image sub-portions with media elements of a set of media elements, in the example of FIG. 2 with music files or tracks of an album. A sub-portion 210 of an image 200 associated with the set may be associated with one of the music files of the album. Such image sub-portion may also be referred to as song art. For example, the image sub-portion ‘5’ is associated with a song ‘Still going strong’. Then, the image sub-portion may be displayed when playing the associated music file, for example.

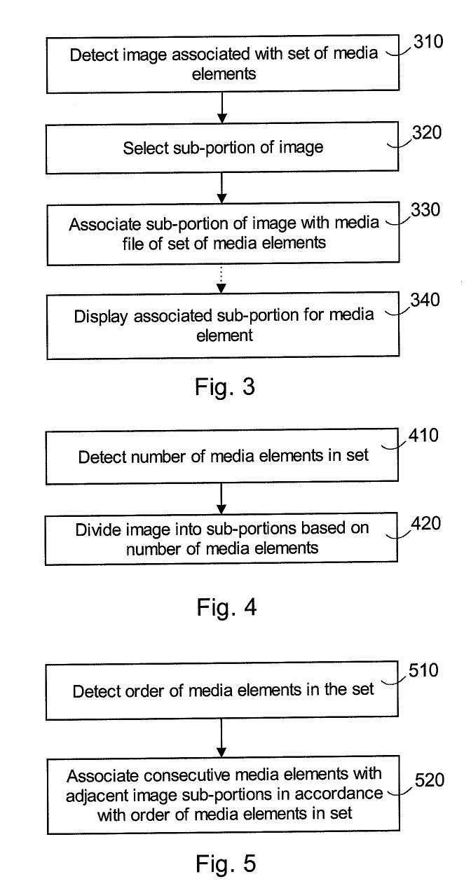

FIG. 3 shows a method for providing supplementary visual aid for media elements according to an example embodiment. The method may be applied as a control algorithm by a controller of an electronic device comprising a media player, for example.

An image associated with a set of media elements, such as an album cover image 200 of a set of music files representing an album, is detected 310. An image stored in connection with the set of media elements, or otherwise associated with the set, may thus be retrieved from memory or another device. The image may be associated with the set in various ways. For example, an image file may be stored in the same folder as the media element(s), or otherwise indicated for or linked with the set of media elements. It is to be appreciated that the image need not to be a specific image pre-specified to represent the set, but it is possible to select any other image, e.g. a view extracted from an introductory video file, to be associated with the set.

A plurality of image sub-portions may be formed of the image associated with the set of media elements. A sub-portion of the image is selected 320 and associated 330 with at least one media element of the set of media elements. The association of the image sub-portion with the media element is to be understood broadly, to cover linking, attachment, inclusion in same file or folder, for example. It will be appreciated that blocks 310 to 330 may be repeated for each media file of the set. These blocks may be carried out when at least one media element of the set of media elements is to be played and/or indicated to the user for the first time, or each time before such action, for example. The associated image sub-portions may be stored for later use in a memory, e.g. as icon images.

Then, the image sub-portion may be later displayed 340 when playing the associated media element, displaying information on the associated media element, and/or displaying a view with information on the set of media elements, for example. Block 340 may be entered immediately or upon further trigger when there is a need to display information related to the media element.

This enables to provide further visual aid for the user to differentiate between media elements of the set. A user interface of an apparatus, such as a mobile communications device with a media player, may be configured to provide at least some of the input/output related functions of FIG. 3. An image processing algorithm in the apparatus carrying out the features of FIG. 3 may be applied to perform image processing to have the image sub-portions associated with the media elements. It is to be appreciated that various modifications and additions may be made to the example method of FIG. 3. Some further example embodiments are illustrated below.

FIG. 4 illustrates an embodiment, which may be applied when associating image sub-portions with media elements of a set of media elements, e.g. in block 330. The number of media elements in the set of media elements is detected 410. The image is divided 420 to a number of sub-portions on the basis of the number of media elements. For example, if the album comprises 8 songs, the album cover image is partitioned into 8 sub-images.

However, it is to be appreciated that other criterion may be applied, instead of or in addition to the number of media elements, for generating the image sub-portions on the basis of the image. In one example embodiment, the image is divided into the sub-portions on the basis of lengths of individual media elements. For example, a media file with a longer duration is associated with a larger portion of the image than another media file with a shorter duration. Thus, the proportions of the sub-images of the entire image may vary on the basis of the number of the media elements in the set and/or the lengths of the media elements. It is to be noted that it is possible to adapt the sizes of display of the sub-images on the basis of this or other criteria.

It is not necessary to use the entire image area for forming the image sub-portions. In some embodiments, the image processing algorithm may be arranged to filter out portions, such as corners, of the image and generate the sub-portions after filtering.

In one embodiment, the image processing algorithm may be arranged to further analyze the image, and filter out portions comprising content with predefined properties. The algorithm may be configured to filter out portions not comprising visually useful cues or deviations (e.g. background portions of the image). In a further example embodiment, the image processing algorithm may be configured to compare similarity of portions of the image associated with the set, and avoid using similar portions when selecting 320 the image sub-portions. For example, the algorithm may be arranged to detect colors of portions of the image associated with the set and compare the similarity of the portions on the basis of detected colors.

In some embodiments, the media elements in the set of media elements are in a predefined order. As illustrated in FIG. 5, the order of the media elements may be detected 510, e.g. before entering block 420. Consecutive media elements may then be associated 520 with adjacent image sub-portions in accordance with the order of the media elements in the set.

For example, the generation of the image sub-portions may be selected in consecutive order from right to left and up to down. A first image sub-portion of left side upper corner of the image may be selected for the first media element of the set, a second media element portion on right side of the first image sub-portion may be selected for the second media element of the set and so on. However, it will be appreciated that the image sub-portions may be selected in various other ways and it is not necessary to select the sub-portions in consecutive order.

In one embodiment, an apparatus carrying out at least some of the above indicated features is arranged to detect the position of a media element in the order of the set of media elements. An order or position indicator, such as an order number, is associated with the image sub-portion associated with the media element. As illustrated in FIG. 2, such indicator may be on top of or part of the image sub-portion, but many other association and display options are also naturally possible.

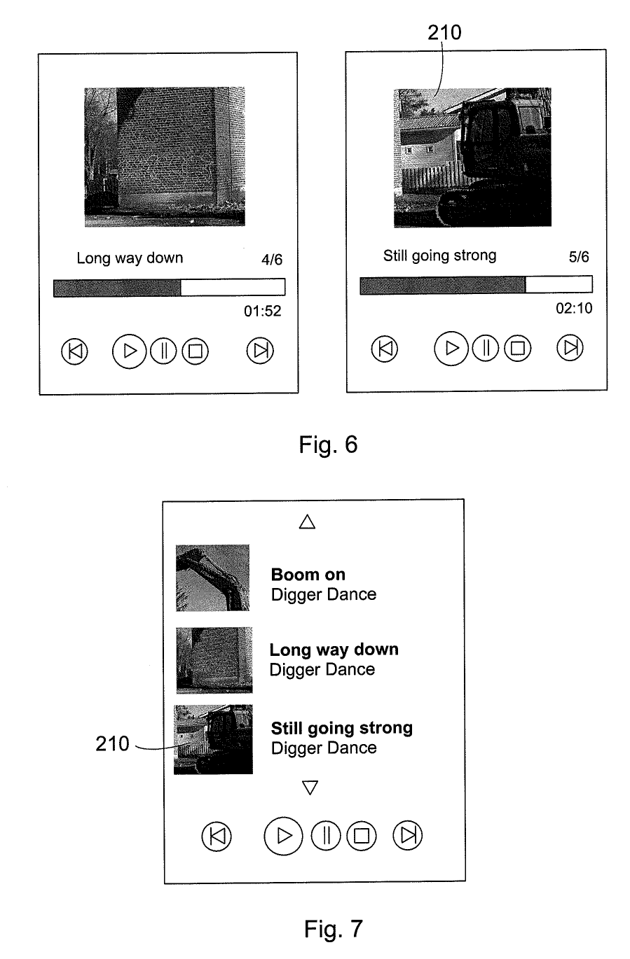

FIGS. 6 to 7 illustrate some example display views. FIG. 7 illustrates an example of a list view, in which each media file of a set is displayed with the associated image sub-portion.

Besides music files, the present features may be applied for other media types. For example, sections or chapters of a movie or an e-book may be similarly associated with image sub-portions generated based on an image, such as a cover image. Furthermore, it will be appreciated that the apparatus may be configured to display further visualizing and advising information. For example, also the entire image could be displayed close to the name of the album when playing a music file or displaying the tracks of the album.

In some embodiments, an action is triggered for the media element upon detecting a user input for the associated image sub-portion. The device may be configured to enter a display mode displaying a plurality of image sub-portions simultaneously, each of the sub-portions associated with a different media element. In response to detecting a user input for one of the displayed image sub-portions, selection of a media element associated with the selected image sub-portion may be controlled. For example, when the user touches or otherwise selects the image sub-portion in a favorite music list view, a music player is automatically activated and the associated song is played. Thus, the generated image sub-portion may serve as starting point for the user for actions regarding the associated media file.

The apparatus carrying out at least some of the above indicated features may be configured to adapt the associations and display views according to the current operating state of the device, a user input, or an application executed in the device, for instance. For instance, associations may be application specific, menu specific, view specific and/or context (which may be defined on the basis of information obtained from the current environment or usage of the device) specific.

In some embodiments, the image sub-portion generation and association (blocks 310 to 330) is carried out by another entity or device than the subsequent use (340) of the image sub-portions. For example, a media provider device or a media server may perform the image partitioning and media element association prior to downloading or otherwise providing the media set to playback electronic devices.

It will be appreciated that the device may be configured to display image sub-portions in various ways. For example, the image sub-portions need not to be rectangular, but various other shapes may be used. Further visual effects or processing may be applied for the image sub-portions. For example, image sub-portions may be rotated, tilted, etc. In a still further example, during consumption of the media, such as music playback, the image or image sub-portions may be animated. For example, the image for a music track or file may be visualized to rotate with speed relative to the progress of the music track playback.

The apparatus may be arranged to provide the user with a possibility to select the image sub-portions and/or further edit the image sub-portions. Thus, the image sub-portion may be selected 320 in accordance with an input from the user. An image processing view/application may be initiated in response to the user selecting image sub-portioning or modification of an image sub-portion. The image sub-portion may be edited in accordance with inputs from the user, and the modified image sub-portion may be stored in association with the related media element (and may replace an earlier stored image sub-portion). For example, the user crops a portion of an album image and drags the image sub-portion above a song of the album. This enables the user to select a portion of the album cover e.g. best representing her favorite song.

In an embodiment, detection of a specific user input may trigger a specific further action regarding one or more image sub-portions. For example, in response to detecting a shaking movement of the apparatus the display positions of the image sub-portions is changed e.g. the imitate movement caused by the shaking.

In an embodiment, if media files are selected to a play list, a play list image may be generated on the basis of the image sub-portions associated with the media files selected on the play list.

In an embodiment, a zoom operation may be performed for an image associated with the set of media elements and/or an image sub-portion associated with a media element of the set. For example, starting from the image associated with the set, the user may zoom in to one or more image sub-portions. For example, a touch or hovering input to a portion of the image may be detected, and the zoom in function is activated for the selected portion of the image. Reference is again made to FIG. 2, in which the user may tap the 5^{th} image sub-portion 210 and thus zoom in to see a larger view of this sub-image and possibly other information, such as the details of the 5^{th} track of the album. Another example is that when a zoom-out input from an image sub-portion is detected, display of the image is triggered. Thus, this provides a new method for informing the user of the contents of the set of media elements. New user interaction possibilities are enabled and the user may easily change between the set and one or more media elements of the set. Further, it will be appreciated that further supplementary information or output, such as audible and/or haptic output, may be provided for the media element in question. For example, when a particular song is being selected or currently focused in a list view, a portion of the song may be played.

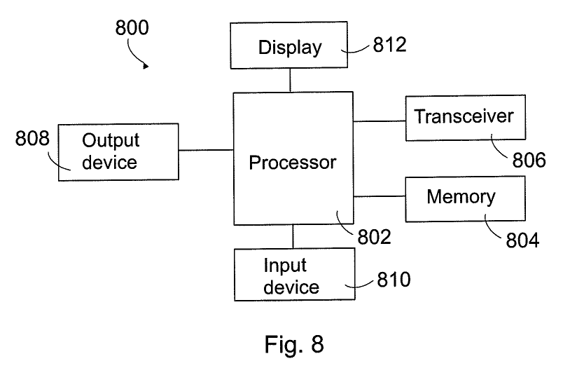

FIG. 8 shows a block diagram of the structure of an electronic device 800 according to an example embodiment. The electronic device may comprise an apparatus configured to perform at least some of the above indicated features. Although one embodiment of the electronic device 800 is illustrated and will be hereinafter described for purposes of example, other types of electronic devices, such as, but not limited to, PDAs, pagers, mobile computers, desktop computers, laptop computers, tablet computers, media players, televisions, gaming devices, cameras, video recorders, positioning devices, electronic books, wearable devices, projector devices, various touch-enabled devices, and other types of electronic systems, may employ the present embodiments.

Furthermore, the apparatus of an example embodiment need not be the entire electronic device, but may be a component or group of components of the electronic device in other example embodiments. For example, the apparatus could be in a form of a chipset or some other kind of hardware module for controlling by performing at least some of the functions illustrated above, such as at least some of the features illustrated in FIGS. 3 to 5.

A processor 802 is configured to execute instructions and to carry out operations associated with the electronic device 800. The processor 802 may comprise means, such as a digital signal processor device, a microprocessor device, and further circuitry, for performing various functions including, for example, one or more of the functions described in conjunction with FIGS. 3 to 5. The processor 802 may control the reception and processing of input and output data between components of the electronic device 800 by using instructions retrieved from memory.

The processor 802 can be implemented on a single-chip, multiple chips or multiple electrical components. Some examples of architectures which can be used for the processor 802 include a dedicated or embedded processor, and ASIC. For simplicity, the processor 802 is illustrated in FIG. 8 as a single block, but it will be appreciated that the electronic device 800 may comprise a plurality of control sub-systems, such as one or more of an I/O sub-system, an application processing sub-system and communications protocol processing sub-system, each of which may comprise one or more controllers. It is to be appreciated that there may be a specific controller, by the processor 802 or another data control entity, carrying out at least some of the features illustrated above in connection with FIGS. 3 to 5. There may be further specific functional module(s), for instance to provide the means for carrying out one or more of the blocks described in connection with FIGS. 3 to 5.

The processor 802 may comprise functionality to operate one or more computer programs. Computer program code may be stored in a memory 804. The at least one memory and the computer program code may be configured to, with the at least one processor, cause the apparatus to perform at least one embodiment including, for example, control of one or more of the functions described in conjunction with FIGS. 3 to 5. Typically the processor 802 operates together with an operating system to execute computer code and produce and use data.

By way of example, the memory 804 may include non-volatile portion, such as EEPROM, flash memory or the like, and a volatile portion, such as a random access memory (RAM) including a cache area for temporary storage of data. Code for controlling the functionality of the processor 802 could also reside on a removable storage medium and loaded or installed onto the electronic device 800 when needed. In addition to storing code, the memory 804 may comprise parameters e.g. affecting the operation of the control algorithm, media elements, such as music files, image(s) associated with the set of media elements, and image portions associated with media elements, or some or all of such data may be stored in another internal or external memory.

The electronic device 800 may comprise an antenna (or multiple antennae) in operable communication with a transceiver unit 806 comprising a transmitter and a receiver. The electronic device 800 may operate with one or more air interface standards and communication protocols. By way of illustration, the electronic device 800 may operate in accordance with any of a number of first, second, third and/or fourth-generation communication protocols or the like. For example, the electronic device 800 may operate in accordance with wireline protocols, such as Ethernet and digital subscriber line (DSL), with second-generation (2G) wireless communication protocols, such as Global System for Mobile communications (GSM), with third-generation (3G) wireless communication protocols, such as 3G protocols by the Third Generation Partnership Project (3GPP), CDMA2000, wideband CDMA (WCDMA) and time division-synchronous CDMA (TD-SCDMA), with fourth-generation (4G) wireless communication protocols, such as 3GPP Long Term Evolution (LTE), wireless local area networking protocols, such as 802.11, short-range wireless protocols, such as Bluetooth, and/or the like.

The user interface of the electronic device 800 may comprise an output device 808, such as a speaker, one or more input devices 810, such as a microphone, a keypad or one or more buttons or actuators, and a display device 812 appropriate for the electronic device 800 in question. The data processor may be configured to provide a controller to control different application views on the display 812 as illustrated above.

The input device 810 may include a touch sensing device configured to detect an input in response to a user's touch and to send an input indication to the processor 802. Such touch sensing device may be configured to recognize also the position and magnitude of touches on a touch sensitive surface. The touch sensing device may be based on sensing technologies including, but not limited to, capacitive sensing, resistive sensing, surface acoustic wave sensing, pressure sensing, inductive sensing, and optical sensing. In one embodiment, the input device is a touch screen, which is positioned in front of the display 812.

The electronic device 800 may comprise also further units and elements not illustrated in FIG. 8, such as further interface devices, sensors (e.g. a proximity sensor and/or an accelerometer sensor), a battery, a media capturing element, such as a camera, video and/or audio module, a positioning unit, and a user identity module.

The apparatus 800 may comprise a stereoscopic display capable of displaying stereoscopic views. The stereoscopic display may be arranged to generate 3D view(s), i.e. views comprising the entire view or at least some display elements with 3D effects and visualized at various depth levels. 3D effects and views may be applied also for the image and the image sub-portions.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 8. A computer-readable medium may comprise a tangible and non-transitory computer-readable storage medium that may be any media or means that can contain or store the instructions for use by or in connection with an instruction execution system, apparatus, or device, such as a computer.

In one example embodiment, there may be provided circuitry or user interface circuitry configured to provide at least some control functions illustrated above. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

If desired, at least some of the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
at least one processor; and
at least one memory including computer program code,
the at least one memory and the computer program code configured to, with the at least one processor, cause the apparatus at least to:
detect an image associated with a set of media elements,
select a sub-portion of the image, and
associate the sub-portion of the image with a media element of the set of media elements.

2. An apparatus, comprising:
means for detecting an image associated with a set of media elements,
means for selecting a sub-portion of the image, and
means for associating the sub-portion of the image with a media element of the set of media elements.

3. The apparatus of claim 1, wherein the media elements are music files and the set of media elements represents an album or a play list of music files.

4. The apparatus of claim 1, wherein the apparatus is configured to display the sub-portion of the image during one or more of playing said media element of the set of media elements, displaying information on said media element, and displaying a view with information on the set of media elements.

5. The apparatus of claim 1, wherein the apparatus is configured to:
detect the number of media elements in the set of media elements, and
divide the image to sub-portions on the basis of the number of media elements.

6. The apparatus of claim 1, wherein the media elements in the set of media elements are in a predefined order, and the apparatus is configured to detect the order and associate consecutive media elements with adjacent image sub-portions in accordance with the order of the media elements.

7. The apparatus of claim 6, wherein the apparatus is configured to:
detect the position of a media element in the set of media elements, and
display the image sub-portion with an indicator of the position of the media element in the set of media elements.

8. The apparatus of claim 1, wherein the apparatus is configured to:
enter a display mode displaying a plurality of image sub-portions simultaneously, each of the image sub-portions associated with a different media element,
detect a user input for one of the displayed image sub-portions, and
control selection of a media element associated with the selected image sub-portion.

9. The apparatus of any preceding claim 1, wherein the apparatus is configured to divide the image into the sub-portions on the basis of lengths of individual media elements.

10. The apparatus of claim 1, wherein the apparatus is a mobile communications device comprising a touch screen.

11. A method, comprising:
detecting an image associated with a set of media elements,
selecting a sub-portion of the image, and
associating the sub-portion of the image with a media element of the set of media elements.

12. The method of claim 11, wherein the media elements are music files and the set of media elements represents an album or a play list of music files.

13. The method of claim 11, wherein the sub-portion of the image is displayed during one or more of playing said media element of the set of media elements, displaying information on said media element, and displaying a view with information on the set of media elements.

14. The method of claim 11, wherein the number of media elements in the set of media elements is detected, and
the image is divided to sub-portions on the basis of the number of media elements.

15. The method of claim 11, wherein the media elements in the set of media elements are in a predefined order, and
consecutive media elements are associated with adjacent image sub-portions in accordance with the order of the media elements.

16. The method of claim 15, wherein the position of a media element in the set of media elements is detected, and
the image sub-portion is displayed with an indicator of the position of the media element in the set of media elements.

17. The method of claim 11, further comprising:
entering a display mode displaying a plurality of image sub-portions simultaneously, each of the image sub-portions associated with a different media element,
detecting a user input for one of the displayed image sub-portions, and
controlling selection of a media element associated with the selected image sub-portion.

18. The method of claim 11, wherein the image is divided into the sub-portions on the basis of lengths of individual media elements.

19. A computer program product comprising a computer-readable medium bearing computer program code embodied therein for use with an apparatus, the computer program code comprising code for causing the apparatus to
detect an image associated with a set of media elements,
select a sub-portion of the image, and
associate the sub-portion of the image with a media element of the set of media elements.
